(19) United States
(12) Patent Application Publication
(10) Pub. No.: US 2011/0006553 A1
(43) Pub. Date: Jan. 13, 2011

(54) Winch Carrier and Grille Guard Mounting System

(75) Inventors: Darren G. Fretz, Canby, OR (US); Steven M. Schile, Portland, OR (US)

Correspondence Address: HARNESS, DICKEY & PIERCE, P.L.C., P.O. BOX 828, BLOOMFIELD HILLS, MI, 48303, US

(73) Assignee: WARN INDUSTRIES, INC., Milwaukie, OR (US)

(21) Appl. No.: 12/498,654

(22) Filed: Jul. 7, 2009

(51) Int. Cl. B60R 19/52; B62D 23/00

(52) U.S. Cl. 293/115; 296/1.07

(57) ABSTRACT

An accessory mounting system for on-road and off-road passenger vehicles, such as light-duty trucks and SUV's is provided. The system attaches to a vehicle to serve as an extension of the vehicle frame to provide a secure mounting location for vehicle accessories, such as a winch, grille guards, headlamp guards, and lights. The system provides for the attachment of numerous accessory components without modification or replacement of an original equipment bumper.

### FIELD

The present disclosure relates generally to vehicle accessories for enhancing the styling and functionality of vehicles, and more particularly, to an accessory mounting system that provides secure attachment for a winch or other vehicle accessories.

### BACKGROUND AND SUMMARY

This section provides background information related to the present disclosure, which is not necessarily prior art. This section also provides a general summary of the disclosure but not a comprehensive disclosure of its full scope or all of its features.

Grille guards, also known as brush guards, are common accessories for larger, on-road and off-road passenger vehicles, such as light-duty trucks and SUV's. Such accessories may add to the aesthetic appearance of the vehicle, serve to protect the front of the vehicle from damage, and provide attachment for other accessory components.

A winch is another common truck and SUV accessory. A winch is a mechanical device that winds in or lets out a rope, belt, or cable. In light truck and SUV applications, an operator often uses a winch as a pulling device to free a stuck vehicle, such as when operating a vehicle off-road. Typically, the operator attaches an end of a winch cable to a secure object, such as a tree or other vehicle, and engages the winch to draw in the cable. As the winch draws in the cable, it pulls the vehicle toward the secure object, thus freeing the vehicle.

A winch must attach properly to a vehicle frame to distribute the pulling load and avoid structural damage to the vehicle. Attaching a winch directly to a vehicle frame may not always be possible or desirable, as with most on-road and off-road passenger vehicles, the vehicle frame is not exposed to the outside of the vehicle. In such situations, a winch may attach indirectly to the vehicle frame with mounting brackets or may attach to a bumper or grille guard that is already attached to the vehicle frame. Adding a grille guard may not be possible, such as when a winch is already mounted to a vehicle; the winch mounting hardware and the grille guard often use the same attachment locations on the vehicle frame.

The system of the present disclosure provides a secure winch mounting attachment to the vehicle frame via a winch carrier and allows for the subsequent addition of a grille guard and other accessories without further attachment to the vehicle frame.

Bumper replacement systems, often called winch-mount bumpers, can serve as a platform to securely mount vehicle accessories, such as winches, grille guards, lights, and headlamp guards. To install such systems on a vehicle, a factory-installed bumper is removed and replaced with the bumper replacement system. A bumper replacement system can drastically change the aesthetic appearance of the vehicle as the most common bumper replacement systems are steel weldments that do not conform to the more-rounded-shapes of late-model vehicles.

The system of the present disclosure provides a secure winch mounting attachment to the vehicle frame and allows for the subsequent addition of a grille guard and other accessories without permanently removing the factory-installed bumper. The system of the present disclosure can provide many of the features of bumper replacement systems, while providing a less dramatic change to a vehicle's aesthetic appearance.

The system of the present disclosure also provides a removable grille guard, while maintaining the installed winch carrier. While the grille guard may permanently attach to the winch carrier, the system also allows the grille guard to removably attach to the winch carrier. One may choose to remove the grille guard to service the front end of the vehicle or to change the appearance of the vehicle.

Grille guards that mount to the vehicle frame often comprise two vertical side members and at least one horizontal cross member. Such grille guards are often a multi-piece design to balance manufacturing and shipping costs with often-complex vehicle frame mounting brackets. Flat, vertical side members are a common component of multi-piece, bolt-on grille guards.

The system of the present disclosure also provides a one-piece grille guard. Because the winch carrier mounts to the vehicle frame the grille guard does not need to provide an interface to the vehicle frame. The interface of the grille guard to the winch carrier can be simple, when compared to mounting the grille guard to the vehicle frame. Because the grille guard of the present disclosure mounts to the winch carrier using a simple interface, more options are available for the design and shape of the grille guard. The system of the present disclosure is not limited to a one-piece grille guard and can accept multi-piece grille guards.

The system also provides a grille guard that can have a rounded (tubular) cross-sectional appearance. Grille guards of a rounded cross-sectional appearance are often incorporated into bumper replacement systems but are not easily incorporated into bolt-on, grille guard systems. As a one-piece grille guard is a less-complex assembly, rounded materials are easier to incorporate in a design. The system is not limited to a rounded grille guard and can accept grille guards of other cross-sectional shapes.

The system also provides for attachment of other accessory components to the winch carrier and grille guard. Examples of such accessory components are fairleads, lights, light bars, headlamp guards, and receivers.

The present disclosure describes the system mounted to light-duty trucks and SUV's. The system is not limited to use on such vehicles and may apply to vans, sedans, all-terrain vehicles (ATV's), and tractors, among other vehicle types.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in anyway.

FIG. 1A is an exploded perspective view of a prior art grille guard assembly;

FIG. 1B is an exploded perspective view of a prior art grille guard and a winch mount system;

FIG. 2A is an exploded perspective view of a winch mounting system, according to the principles of the present disclosure;

FIG. 2B is an exploded perspective view of a winch mounting and grille guard system, according to the principles of the present disclosure;

FIG. 3 is a rear perspective view of a winch mounting and grille guard system, according to the principles of the present disclosure;

FIG. 4 is an exploded perspective view of a winch mounting and grille guard system having additional accessories shown therewith; and

FIG. 5 is a perspective view of a winch mounting and grille guard system, according to the principles of the present disclosure, shown installed on a vehicle with additional accessories mounted thereon; and

### DETAILED DESCRIPTION

Example embodiments will now be described more fully with reference to the accompanying drawings.

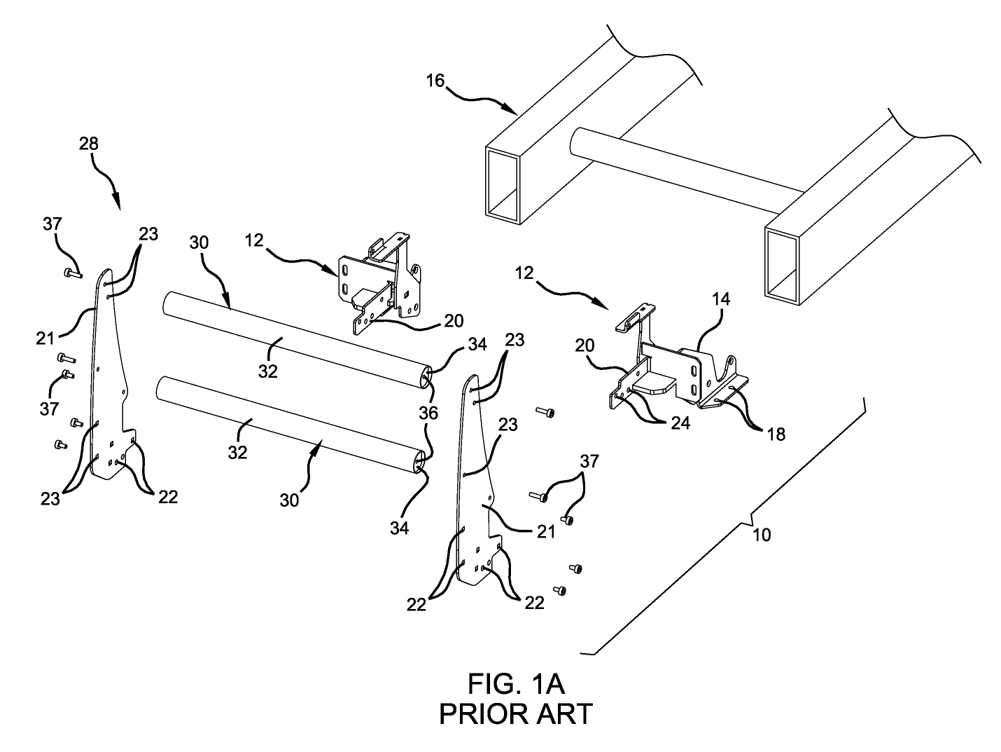

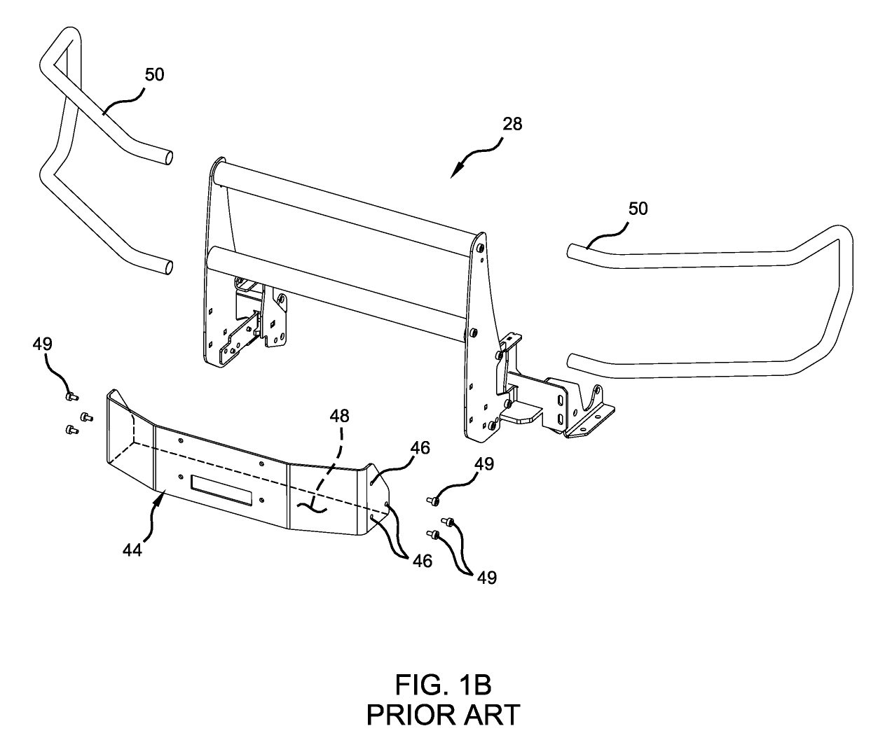

With reference to FIGS. 1A and 1B, a prior-art, vehicle grille guard and winch mount system 10 for mounting to a forward end of a vehicle will be described. The vehicle grille guard and winch mount system 10 includes a pair of mounting brackets 12. Rear mounting flanges 14 of mounting brackets 12 are adapted to securely attach to a vehicle frame 16. Further reference to the vehicle frame can also include a sub-frame, mounting brackets, or any adaptive mounting feature installed on the vehicle. A plurality of holes 18 incorporated into rear mounting flanges 14 receives fasteners to attach mounting brackets 12 to the vehicle frame 16. Mounting brackets 12 may take advantage of existing threaded holes on vehicle frame 16 or additional threaded holes may need to be added to vehicle frame 16 to secure mounting brackets 12 to vehicle frame 16. Forward mounting flanges 20 of mounting brackets 12 are adapted to attach to vertical side members 21. Vertical side members 21 are often substantially flat components with a plurality of through-holes 22 for attaching to mounting brackets 12 and through-holes 23 for attaching to other components in the grille guard and winch mount assembly 10. A plurality of holes 24 incorporated into forward mounting flanges 20 receive fasteners to attach mounting brackets 12 to vertical side members 21 using through-holes 22. At least one horizontal cross-member 30 mounts between vertical side members 21. Typically, a horizontal cross member 30 is comprised of a tubular component 32 and a pair of mounting inserts 34 each with a threaded hole 36. A pair of threaded fasteners 37 passes through holes 23 of vertical side members 21 and thread into holes 36 of inserts 34. The vertical side members 21, horizontal cross members 30, and mounting brackets 12 form the grille guard assembly 28.

The grille guard assembly 28 serves as an extension of the vehicle frame 16, upon which additional accessories may mount. One such accessory is a winch carrier 44, as shown in FIG. 1B. Winch carrier 44 may comprise mounting holes 46 and a mounting surface 48. The winch carrier 44 may attach between vertical side members 21 of the grille guard assembly 28. Typically, fasteners 49 are inserted through holes 23 of the vertical side members 21 and into holes 46 of the winch carrier 44. Additional accessory components may mount to the grille guard system. An accessory component such as a winch may mount to a surface 48 of winch carrier 44. Headlamp guards 50 may mount to the vertical side members 21. Other examples of accessory components will subsequently be described with respect to the present disclosure.

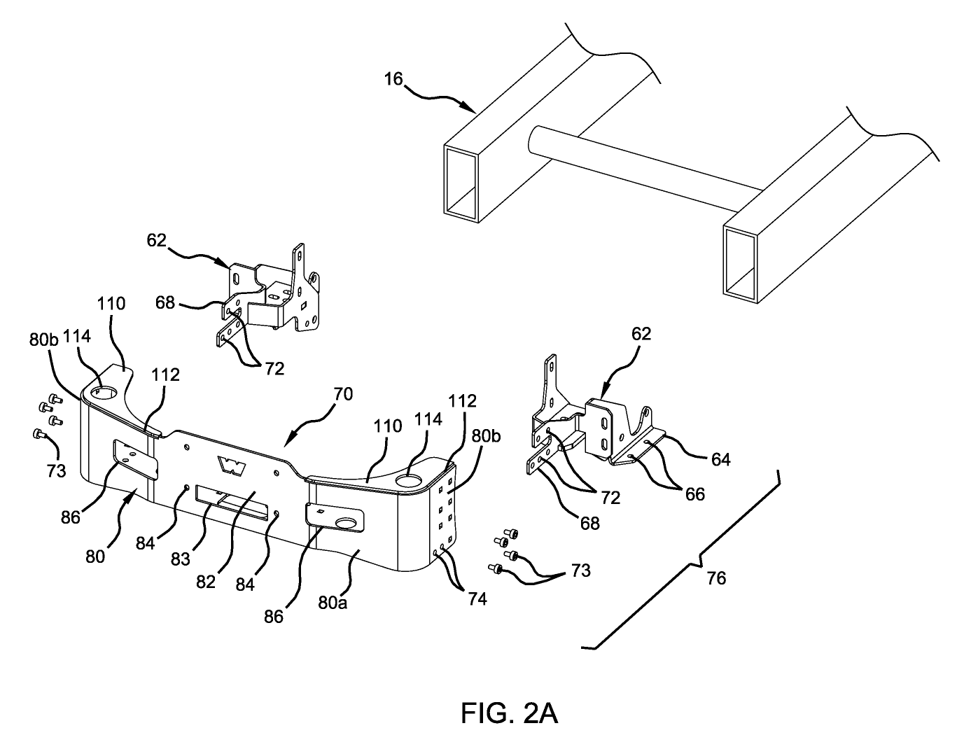

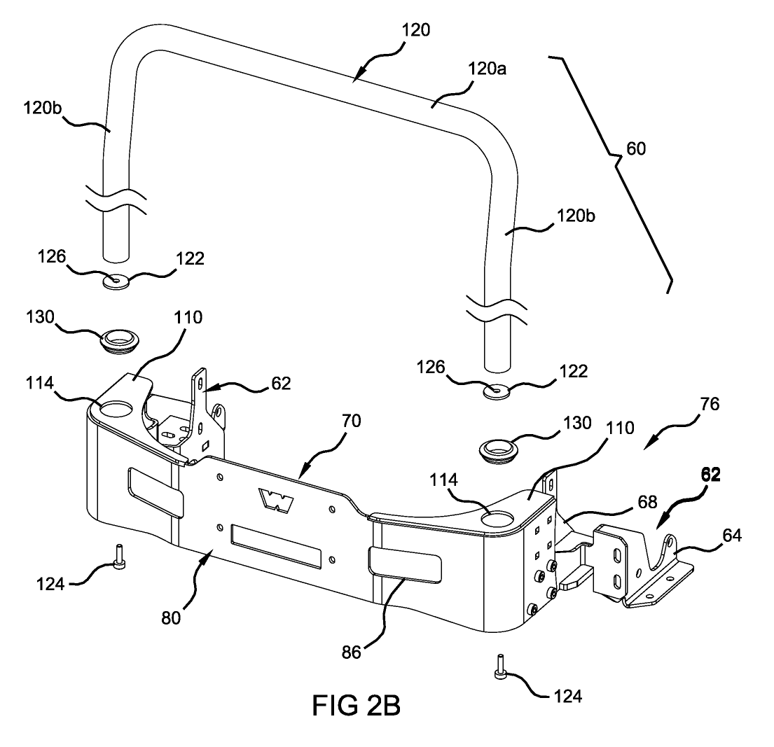

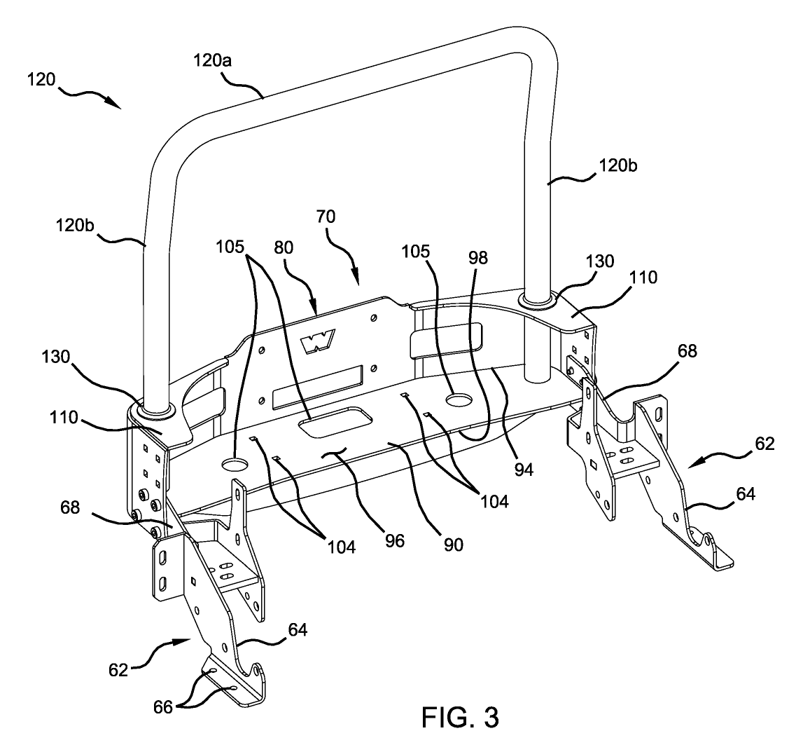

With reference to FIGS. 2A, 2B, and 3, a winch mounting and grille guard system 60 will now be described, according to the principles of the present disclosure. The winch mounting and grille guard system 60 includes a pair of mounting brackets 62. Rear mounting flanges 64 of mounting brackets 62 are adapted to securely attach to a vehicle frame 16. A plurality of holes 66 incorporated into rear mounting flanges 64 receive fasteners to attach mounting brackets 62 to the vehicle frame 16. Mounting brackets 62 may take advantage of existing threaded holes on vehicle frame 16 or additional threaded holes may need to be added to vehicle frame 16 to secure mounting brackets 62 to vehicle frame 16. Forward mounting flanges 68 of mounting brackets 62 are adapted to attach to a winch carrier 70. A plurality of holes 72 incorporated into forward mounting flanges 68 receive fasteners 73 to attach mounting brackets 62 to holes 74 of winch carrier 70. Winch carrier 70 and mounting brackets 62 form a winch mounting system 76.

The winch mounting system 76 of FIG. 2A is comparable to the prior art, grille guard assembly 28 of FIG. 1A. Both are foundations to mount accessory components. An advantage the winch mounting system 76 offers over the grille guard assembly 28 is only the winch carrier 70 needs to be installed on a vehicle to mount accessory components, such as a winch and auxiliary lights. A grille guard accessory component could optionally be added later, as will be described. The grille guard assembly 28 requires installation of side members 21 and horizontal cross members 30 (forming a grille guard) to be installed on a vehicle before accessory components can be installed.

The winch carrier 70 may be a welded assembly or a single-piece design that is comprised of three main sections. A first, substantially vertical section 80 forms the frontal section 80a and two side sections 80b. Frontal section 80a of vertical section 80 provide for a mounting surface 82, fairlead passage 83, accessory mounting holes 84, and cutouts 86 for weigh reduction or airflow. Side sections 80b of vertical section 80 provide for mounting holes 74 for attachment of mounting brackets 62 and accessory components. The vertical section 80 mates to a second section, substantially horizontal bottom section 90, best shown in FIG. 3. Frontal section 80 and bottom section 90 are best joined by welding along the interface 94 of the two components. The top surface of bottom section 90 is defined as mounting surface 96. The opposite side surface is defined as underside mounting surface 98. Mounting surface 96 is comprised of features such as grille guard mounting holes 102, accessory mounting holes 104, and cutouts 105 for weigh reduction, airflow, and water drainage. Vertical section 80 also mates to a pair of third sections, substantially horizontal upper sections 110. Sections 110 can be joined to form a single upper section without substantially changing functionality. Frontal section 80 and upper sections 110 are best joined by welding at the interface 112 of the components. Upper sections 110 provide for through-holes 114 to be used for mounting accessory components.

The winch mounting system 76 serves as an extension of the vehicle frame 16, upon which additional accessories may mount. One such accessory is a grille guard 120, as shown in FIG. 2B. The grille guard 120 of the present disclosure is a round tubular member but can have other shapes as desired. Grille guard 120 is comprised of a substantially horizontal section 120a, two substantially vertical sections 120b, and two inserts 122 that serve to mount the grille guard 120 to the winch carrier 70.

A grille guard 120 mounts to winch carrier 70 by attaching to mounting surface 96, as best shown in FIG. 3. In one embodiment of the disclosure, the grille guard 120 removably attaches to mounting surface 96 using threaded fasteners 124. Fasteners 124 pass through holes 102 in mounting surface 96 and into threaded holes 126 of inserts 122, which are fixedly attached to the grille guard 120. In another embodiment of the disclosure, the grille guard 120 permanently attaches to mounting surface 96 by means including welding. Grommets 130 are disposed in holes 114 of winch carrier 70, such that vertical sections 120b of grille guard 120 pass through grommets 130. Grommets 130 aid the stability of the installed grille guard 120 and limit degradation of a protective coating on the grille guard 120. Grommets 130 also limit noise generated by the grille guard 120 during vibration against upper sections 110.

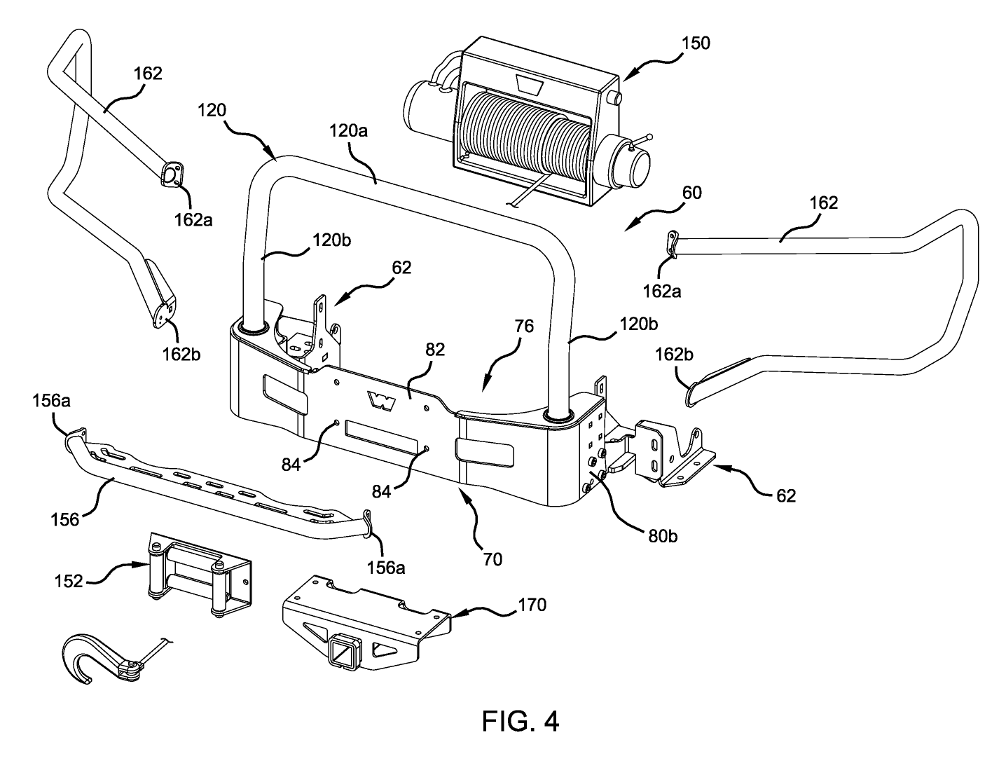

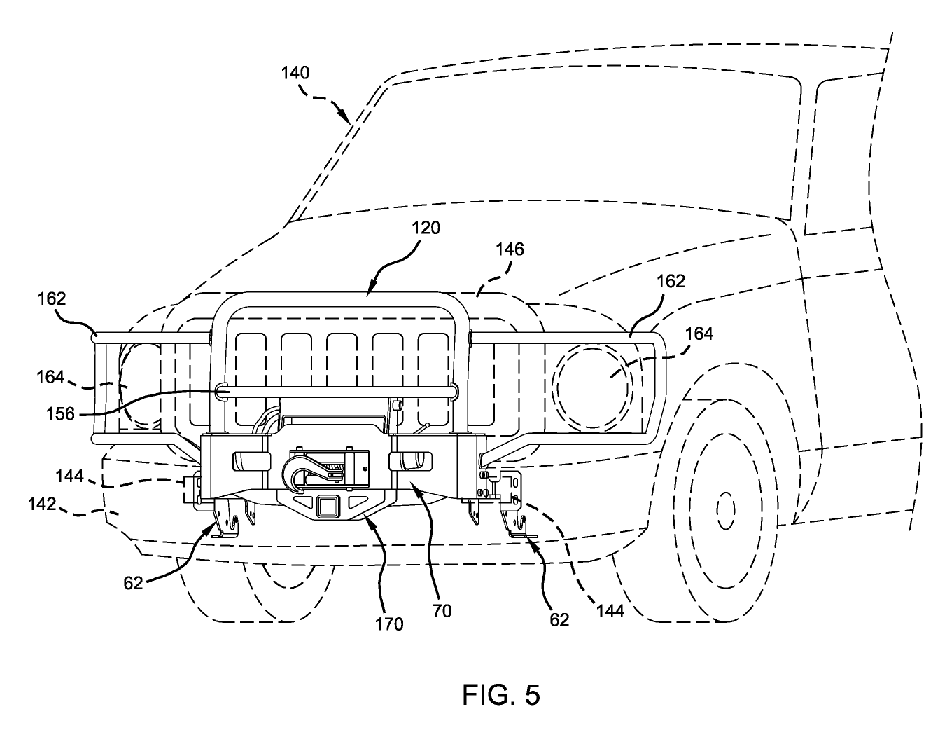

With reference to FIGS. 4 and 5, the installation of the winch mounting and grille guard system 60 on the front of a vehicle 140 with additional accessories mounted thereon will now be described. Mounting brackets 62 attach to a frame 16 of a vehicle 140 as previously described (illustrated in FIG. 2A). The mounting brackets 62 are configured such that modification of an original equipment bumper 142 may be avoided. Forward mounting flanges 68 of mounting brackets 62 may protrude through existing openings 144 in the bumper 142 or alternatively may protrude from underneath the bumper 142. Winch carrier 70 attaches to forward mounting flanges 68 of mounting brackets 62 as previously described to complete a winch mounting system 76.

Using the winch mounting system 76 as a foundation, additional accessory components may be added. One such accessory component is a grille guard 120. One function of an installed grille guard 120 is to protect a vehicle grille 146 from damage caused by objects in the path of the vehicle 140. The grille guard 120 mounted to the winch mounting system 76 together form the winch mounting and grille guard system 60, previously described. Other accessory components may mount to either the winch mounting system 76 or the winch mounting and grille guard system 60.

A winch 150 is another example of an accessory component. Winch 150 attaches to mounting surface 96 of winch carrier 70 (shown in FIG. 3) and secures using threaded fasteners in accessory mounting holes 104. A fairlead 152 is an accessory component that is often used with a winch. A fairlead guides a winch cable during winch use. Fairlead 152 attaches to surface 82 of frontal section 80a of winch carrier 70 using threaded fasteners in accessory mounting holes 84.

The present disclosure also includes a light bar 156 adapted to mount to grille guard 120. Light bar 156 provides a location to securely attach auxiliary lights 158. Mounting flanges 156a of light bar 156 conform to the shape of vertical sections 120b of grille guard 120 and include through-holes such that threaded fasteners may secure light bar 156 to grille guard 120. Light bar 156 removably attaches to grille guard 120 using threaded fasteners or permanently attaches by welding. Auxiliary lights 158 mount to light bar 156 and secure with threaded fasteners. In another embodiment of the disclosure, auxiliary lights may mount directly to winch carrier 70 or may mount to light mounting brackets that attach to mounting surface 96 of winch carrier 70 using accessory mounting holes 84. More than one accessory component may simultaneously attach to winch carrier 70 using accessory mounting holes 84.

Headlamp guards 162 are further examples of accessory components. Headlamp guards 162 serve to protect vehicle headlamps 164 and the surrounding vehicle area from damage by objects in the vehicle path. Headlamp guards 162 removably attach to grille guard 120 and winch carrier 70 using threaded fasteners or permanently attach by welding. Mounting flanges 162a of headlamp guards 162 conform to the shape of vertical sections 120b of grille guard 120 and include through-holes such that threaded fasteners may secure headlamp guard 162 to grille guard 120. Mounting flanges 162b of headlamp guards 162 conform to the shape of side sections 80b of winch carrier 70 and include through-holes such that threaded fasteners may secure headlamp guard 162 to winch carrier 70. However, the present disclosure also contemplates replacing mounting flanges 162b of headlamp guard 162 with a second pair of mounting flanges 162a such that headlamp guards 162 attach only to grille guard 120.

A front receiver 170 is a further example of an accessory component. Front receiver 170 serves primarily to temporarily mount accessory components. Examples of temporary accessory components are trailer hitch inserts and bicycle racks. Front receiver 170 removably attaches to underside mounting surface 98 of winch carrier 70 using threaded fasteners or permanently attaches by welding. Front receiver 170 is secured using threaded fasteners in accessory mounting holes 84.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A vehicle comprising:
a vehicle frame;
a pair of mounting brackets attached directly to said vehicle frame; and
a winch carrier attached directly to said pair of mounting brackets at a position forward of a vehicle bumper.

2. The vehicle according to claim 1, further comprising a grille guard having a substantially horizontal portion, a first substantially vertical portion, and a second substantially vertical portion mounted to said winch carrier separate from said pair of mounting brackets.

3. The vehicle according to claim 2, wherein said winch carrier comprises a substantially vertical frontal section, a first substantially vertical side section extending from said frontal section, a second substantially vertical side section extending from said frontal section, a substantially horizontal bottom section extending from said frontal section, and a pair of substantially horizontal upper sections.

4. The vehicle according to claim 3, wherein said winch carrier comprises a pair of through-holes located in said pair of substantially horizontal upper sections.

5. The vehicle according to claim 4, wherein said grille guard vertical portions locate in said pair of through-holes.

6. The vehicle according to claim 3, wherein said winch carrier bottom section comprises a top mounting surface and an underside mounting surface.

7. The vehicle according to claim 6, further comprising a winch attached to said top mounting surface of said winch carrier via mechanical fasteners.

8. The vehicle according to claim 2, wherein the grille guard further comprises a pair of mounting inserts fixedly attached to said vertical portions.

9. The vehicle according to claim 6, wherein said grille guard removably attaches to said winch carrier top mounting surface via mechanical fasteners.

10. The vehicle according to claim 2, wherein said grille guard further comprises a single, structural member comprising said horizontal portion, said first vertical portion, and said second vertical portion.

11. The vehicle according to claim 10, wherein a cross-sectional shape of said structural member is substantially rounded.

12. The vehicle according to claim 10, wherein said structural member is a tubular member.

13. The vehicle according to claim 2, further comprising a headlamp guard comprising a main member, a first mounting feature, and a second mounting feature, wherein both mounting features fixedly attached to said main member and said mounting features removably attach to said grille guard first vertical portion via mechanical fasteners.

14. The vehicle according to claim 13, wherein said first headlamp guard mounting feature removably attaches to said grille guard first vertical portion via mechanical fasteners and said second mounting feature removably attaches to said winch carrier first side section via mechanical fasteners.

15. The vehicle according to claim 3, further comprising a fairlead removably attached to said winch carrier frontal section via mechanical fasteners.

16. The vehicle according to claim 6, further comprising a front receiver removably attached to said underside surface via mechanical fasteners.

17. An accessory component mounting system comprising:
a winch carrier; and
a pair of mounting brackets attached directly to said winch carrier and adapted to attach to a vehicle; and
a grille guard having a substantially horizontal portion supported between a first substantially vertical portion and a second substantially vertical portion, said first and second substantially vertical portions being mounted to said winch carrier separate from said pair of mounting brackets.

18. The system according to claim 17, wherein said winch carrier comprises a substantially vertical frontal section, a first substantially vertical side section extending from said frontal section, a second substantially vertical side section extending from said frontal section, a substantially horizontal bottom section extending from said frontal section, and a pair of substantially horizontal upper sections extending from respective one of said first substantially vertical side section and said second substantially vertical side section.

19. The system according to claim 18, wherein said winch carrier comprises a pair of through-holes located in said pair of substantially horizontal upper sections.

20. The system according to claim 19, wherein said grille guard vertical portions locate in said pair of through-holes.

21. The system according to claim 18, wherein said winch carrier bottom section comprises a top mounting surface and an underside mounting surface.

22. The system according to claim 21, further comprising a winch attached to said top mounting surface of said winch carrier bottom section via mechanical fasteners.

23. The system according to claim 17, wherein the grille guard further comprises a pair of mounting inserts fixedly attached to said vertical portions.

24. The system according to claim 21, wherein said grille guard removably attaches to said top mounting surface of said winch carrier bottom section via mechanical fasteners.

25. The system according to claim 17, wherein said grille guard further comprises a single structural member including said horizontal portion, said first vertical portion, and said second vertical portion.

26. The system according to claim 25, wherein said structural member is a tubular member.

27. The system according to claim 17, further comprising a headlamp guard comprising a main member, a first mounting feature, and a second mounting feature, wherein both mounting features fixedly attached to said main member and said mounting features removably attach to said grille guard first vertical portion via mechanical fasteners.

28. The system according to claim 27, wherein said first headlamp guard mounting feature removably attaches to said grille guard first vertical portion via mechanical fasteners and said second mounting feature removably attaches to said winch carrier first side section via mechanical fasteners.

29. The system according to claim 18, further comprising a fairlead removably attached to said winch carrier frontal section via mechanical fasteners.

30. The system according to claim 21, further comprising a front receiver removably attached to said underside surface via mechanical fasteners.
